(19) United States
(12) Patent Application Publication
(10) Pub. No.: US 2026/0063577 A1
(43) Pub. Date: Mar. 5, 2026

(54) BACKSCATTER IMAGING SYSTEM FOR INSPECTION OF EQUIPMENT THROUGH INSULATION

(71) Applicant: Varex Imaging Corporation, Salt Lake City, UT (US)

(72) Inventors: Raj Venkatachalam, Salt Lake City, UT (US); Daniel Shedlock, Salt Lake City, UT (US); David Nisius, Salt Lake City, UT (US)

(21) Appl. No.: 18/823,439

(22) Filed: Sep. 3, 2024

(51) Int. Cl. G01N 23/203; G01N 23/20008

(52) U.S. Cl. CPC G01N 23/203; G01N 23/20008; G01N 2223/053; G01N 2223/301; G01N 2223/3303; G01N 2223/631

(57) ABSTRACT

Embodiments are provided to facilitate X-ray backscatter imaging of equipment that is covered by insulation or other materials that it is undesirable to remove and/or that is difficult to access (e.g., due to distance from the ground and/or catwalks or other support structures). These embodiments include improved collimators or other elements to facilitate scanning of the X-ray beam in at least one direction while also maintaining a low size, weight, and power (SWaP). These embodiments also include improved detectors to more readily allow improved X-ray backscatter images and material composition (including detection of the presence of oxides or other evidence or corrosion or degradation) to be detected, even in SWaP-limited applications like remote vessel inspection.

### BACKGROUND

X-ray backscatter may be used for a variety of applications, such as non-destructive imaging of objects or substances through overlaying materials, like packaging. X-ray backscatter includes emitting X-rays toward a target and then detecting the number, energy, direction, and/or other properties of the back-scattered X-rays in order to determine information about the geometry, presence, material composition, or other aspects of the target.

### SUMMARY

In a first aspect, a system is provided that includes: (i) a wall-climbing robot, wherein the wall-climbing robot is configured to selectively attach to a wall while moving along the wall in a first direction relative to a body of the wall-climbing robot; (ii) an X-ray emitter, wherein the X-ray emitter is operable to generate a beam of X-rays and the scan the beam of X-rays in a second direction that is substantially perpendicular to the first direction; and (iii) an X-ray detector, wherein the X-ray detector is operable to detect X-rays emitted from the X-ray emitter and scattered back toward the X-ray detector from the wall.

In a second aspect, a system is provided that includes: (i) an X-ray emitter, wherein the X-ray emitter is operable to generate a beam of X-rays that comprises X-rays at a plurality of different wavelengths and to scan the beam of X-rays in at least one direction; (ii) an X-ray detector, wherein the X-ray detector is operable to detect the wavelength of X-rays received by the X-ray detector; and (iii) a controller comprising one or more processors and configured to perform controller operations including: (a) operating the X-ray emitter to emit a beam of X-rays toward a first location of the target; and (b) operating the X-ray detector to detect X-rays at at least two different wavelengths that are emitted from the X-ray emitter and scattered from the first location of the target.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 depicts an example of a robotic system, according to example embodiments.

FIG. 2 depicts aspects of the operation of a robotic system, according to example embodiments.

FIG. 3 depicts aspects of an X-ray emitter, according to example embodiments.

FIG. 4 depicts aspects of an X-ray backscatter imaging system, according to example embodiments.

### DETAILED DESCRIPTION

It is desirable in a variety of applications to be able to image or otherwise assess the state of a material (e.g., to assess the presence of oxides or other corrosion, cracks, warping, or other degradation of a metal or other material) non-destructively through an intervening material (e.g., a layer of insulation). For example, metallic equipment of a refinery or other chemical processing facility (e.g., cracking towers, distillation towers, and pipes) may be coated in a layer of insulation (e.g., to increase the efficiency of fractionation, distillation, cracking, hydrolysis, and/or other heat-dependent chemical processes occurring therein). To inspect such equipment for the presence of corrosion, cracking, separation of components (e.g., separation of a support ring from the wall of a vessel), or other degradation, it was previously necessary to remove the insulation, perform the inspection, and then re-install or replace the insulation, which is an expensive, time-consuming, and materially wasteful process.

X-rays or other penetrating radiation can be applied to such targets in order to non-destructively image them (e.g., to detect corrosion, cracks, or other defects) without requiring insulation or other covering materials to be removed. However, it can be difficult to apply X-ray imaging to various targets (e.g., metallic pressure vessels) due to their size, proximity to other structures, and other limitations. Conversely, when backscatter X-ray imaging can be applied, it is also difficult to implement due to the size and weight of such systems and the height or otherwise remote nature (e.g., far from catwalks or other supports) of the walls of such targets.

Additionally, the presence of rims, support bands or fins, inspection ports, pipe fittings, or other aspects common to such metallic targets (e.g., support ridges to provide support to a distillation tower at various heights, access ports to access distillates from a tower at various heights) results in complex geometries exhibiting recessed regions otherwise difficult-to-backscatter-image features. Adding to these difficulties is the fact that such ‘difficult’ features are often more likely to exhibit corrosion, cracking, or other degradation (e.g., due to being sites of welds or other joins, due to providing a region for the accumulation of moisture, due to being site of stress focusing within the structure).

The embodiments described herein overcome these limitations, reducing the size, weight, and power (SWaP) of backscatter X-ray imaging systems, allowing them to be used to perform X-ray backscatter imaging of targets with such complex geometry and distance from the ground or other support. These reduced-SWaP embodiments allow the X-ray backscatter imaging systems to be incorporated into wall-climbing robots, allowing such targets to be quickly and easily inspected in a non-invasive manner.

One of these embodiments includes configuring the X-ray backscatter imaging system to scan a beam of X-ray radiation along a first direction the imaging system is incorporated onto or into a wall-climbing robot that is configured to selectively attach to a wall of equipment (e.g., by applying vacuum or other suction thereto) and to move along the wall in a second direction that is substantially perpendicular to the first direction. In this manner, the robot is able to quickly backscatter image the wall in two dimensions (by creating ‘slices’ of image data with each ‘scan’ of the beam in the first direction, and then accumulating a plurality of such slices along the wall in the second direction). Such a configuration allows a two-dimensional area of a target wall to be quickly and accurately imaged while also significantly reducing the size and weight of the scanning X-ray backscatter imaging system by only requiring the system to scan in a single direction substantially perpendicular to the direction of motion of the robotic system along the wall.

FIG. 1 depicts aspects of such a wall-climbing robotic system 100. The system 100 includes tracks 120 or other means to facilitate motion along a wall to which the system 100 is operable to selectively attach (e.g., by applying suction thereto) in a first direction 101. The system 100 also includes a backscatter X-ray imaging system 110 that is configured to image a wall of equipment to which the system 100 is selectively attached by scanning a beam of X-rays toward the wall along a second direction 105 that is substantially perpendicular to the first direction 101. As shown in FIG. 1, this can include rotating a collimator or other element(s) of the imaging system 110 (illustrated by the curved arrow 103). The system 100 may include additional elements, e.g., an actuated visual and/or infrared camera 130 to facilitate visual inspection and/or navigation along the wall. In some embodiments, the wall may be a shell, nozzle, or head of a pressure vessel.

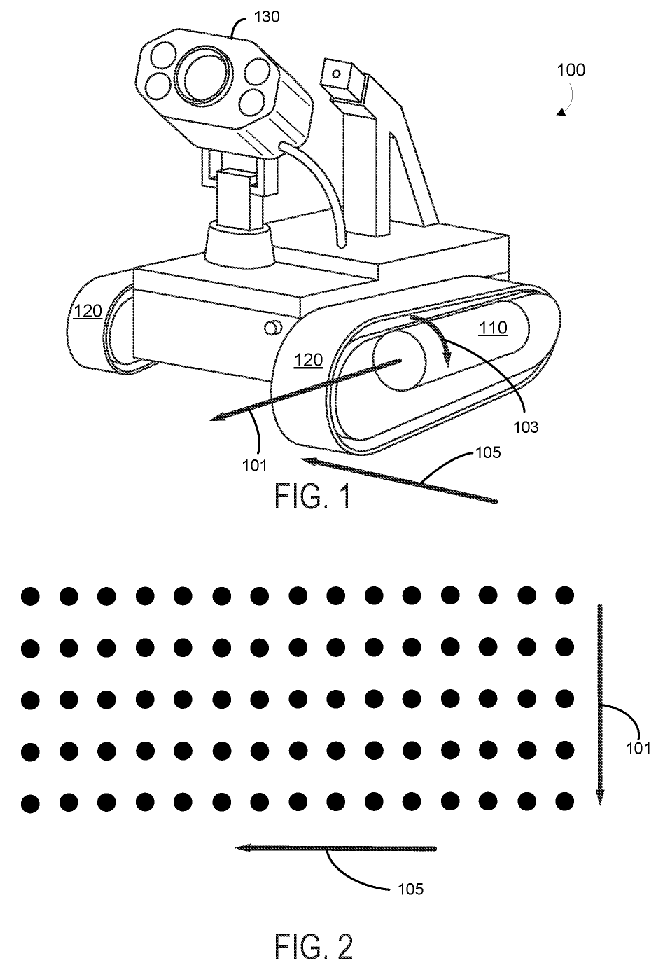

FIG. 2 depicts an example arrangement of separate locations along a wall of equipment (indicated by filled circles) that could be illuminated by the beam of X-rays emitted from the imaging system 110 and X-rays backscattered therefrom detected by the imaging system 110 and used to image the wall. Such locations could be represented as pixels of a backscatter image of the wall. The detected backscattered X-rays could be used to determine a geometry of the wall (e.g., a mesh or other three-dimensional representation of the shape of the wall, a texture or roughness across the wall, the presence of cracks or other features on or in the wall) and/or to determine the composition of the locations of the wall (e.g., to determine the presence of oxides at each of the imaged locations). As shown, rows of imaged locations arranged along the second direction 105 are imaged with each scan of the beam of X-rays along the second direction 105, and motion of the system 100 along the first direction 101 allows subsequent rows of locations, displaced along the first location 101, to be imaged.

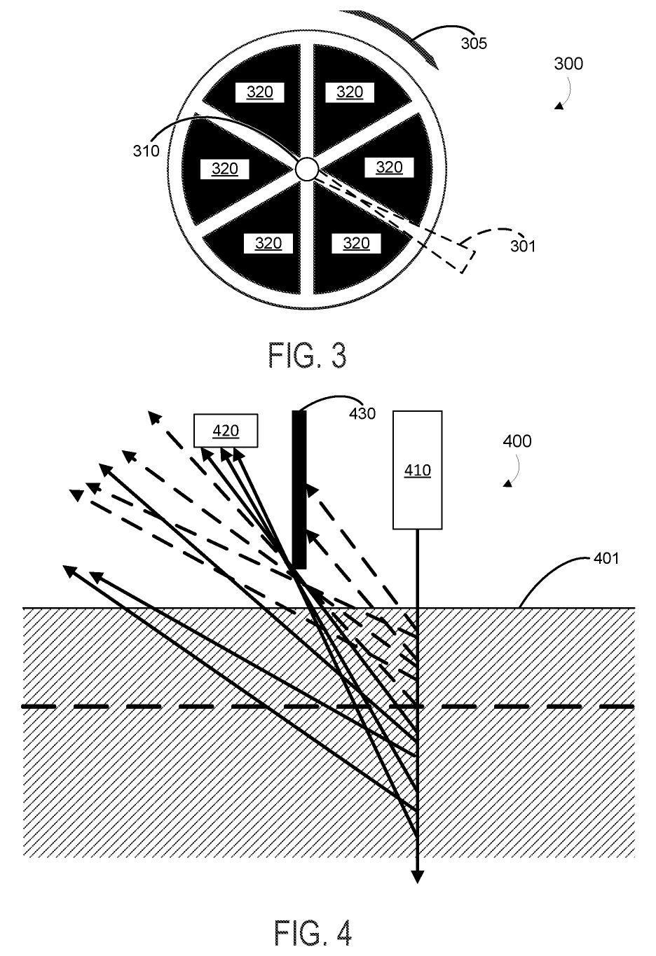

Note that, while the set of locations of imaged location along a wall depicted in FIG. 2 are arranged in an array long perpendicular first 101 and second 105 directions, the arrangement of such locations imaged by a backscatter X-ray imaging system as described herein could be other than perfectly regularly arranged along perpendicular directions. Thus could be due to, e.g., imperfections in the construction or design of such a system, variations in the rate of motion of such a system along a wall and/or in the rate of scanning of a beam of X-rays emitted therefrom along a wall, or other considerations. Accordingly, the angle between a direction of motion of such a system and a direction along which a beam of X-rays emitted therefrom is scanned could be between 85 and 95 degrees, between 80 and 100 degrees, between 70 and 110 degrees, or some other substantially perpendicular angle. In some examples, the angle of the direction along which a beam of X-rays is scanned (e.g., 105 in FIGS. 2 and 3) could be intentionally angled slightly off from perfectly perpendicular to a direction of motion of a robotic wall-climbing system to account for the motion of the system as the beam is scanned, e.g., such that the array of locations of the wall scanned by the system are correspond to a perpendicular array of such locations. Additionally or alternatively, a controller (e.g., of the system) could operate to account for such motion when generating images of a wall imaged by a system as described herein.

A robotic wall-climbing system as described herein (e.g., 100) could be configured to selectively attach to and move along a vertical or otherwise-oriented wall in a variety of ways or combinations of ways. For example, such a system could include a vacuum or other suction source and associated flexible gaskets, flanges, flexible and/or articulated vacuum tubing, or other elements to allow the system to apply vacuum to a wall in order to remain attached thereto, periodically removing vacuum to allow the system to reposition a gasket or other element via which the system allies vacuum to the wall (e.g., while another such element applies vacuum to the wall at another location to maintain the system attached to the wall). Additionally or alternatively, the system could use electrostatic grippers, magnets (e.g., electromagnets), bio-inspired van der Waals grippers, or other elements or processes to selectively attach to a wall. In some examples, the wall could be modified (e.g., a layer of insulation applied to the wall could be modified) to facilitate the system selectively attaching thereto. For example, the wall could be painted with a ferromagnetic paint or otherwise magnetically susceptible substance to facilitate the system 100 selectively magnetically attaching to the wall. In some embodiments, the system 100 may adhere to the wall.

The use of vacuum, magnetics, electrostatics, van der Waals forces, or other techniques to selectively attach such a robotic wall-climbing system to a wall limits the size, weight, available power (e.g., of a battery, or a flexible power-delivering tether), and geometry of such systems. Accordingly, the embodiments described herein provide methods to reduce the SWaP of backscatter X-ray imaging systems while still providing sufficient information about the geometry and/or composition of the wall beneath an overlayer (e.g., of insulation) to inspect the wall and to detect the development of corrosion, cracks, or other damage or defects.

The power of a beam of X-rays sufficient to accomplish backscatter imaging through an overlayer is high (e.g., between 20keV and 600 keV). Previous methods for scanning such a beam of X-rays included moving the X-ray emitter or other bulky components of the imaging system to scan the system in two (or more) directions, resulting in significant increases in the size, weight, and power requirements of systems capable of such actuation. The embodiments described herein rely on the motion of the wall-climbing system to provide scanning of the beam in a first direction (along the direction of motion of the system along a wall), allowing the imaging system to scan the beam in only a single direction. This allows the SWaP of the imaging system to be reduced compared to, e.g., a system that is capable of scanning the beam in both directions.

FIG. 3 depicts, in cross-section, aspects of such an imaging system 300 that uses a rotating, multi-segment collimator 320 to accomplish low-SWaP scanning of a beam of X-rays 301. An X-ray source 310 is located at the center of the collimator 320. The source 310 emits X-rays broadly (e.g., in all directions). The collimator 320 prevents those X-rays from escaping unless they comport with the geometry of a beam 301 between two of the segments of the collimator 320. Rotation of the collimator (e.g., in a direction 305) results in the beam 301 being scanned in a corresponding direction. A non-rotating collimator (not shown) can reduce or prevent beams of X-rays form being emitted from directions other than toward a wall or other target. A rotating collimator sufficient to provide this one-dimensional beam scanning functionality is relatively small and light, and so can be driven to rotate by a relatively low-power (and thus low size and weight) motor, leading to an overall low-SWaP scanning X-ray emitter than is compatible with available wall-climbing robotic systems.

In another example, a backscatter X-ray imaging system could be made capable of controlling the direction of a beam of X-rays emitted therefrom in at least one direction by controlling the direction of a beam of electrons emitted from a cathode thereof toward an anode or other target thereof. The geometry of the target could be selected such that changes in the angle of the beam of electrons relative to the target result in changes in the angle of the resulting beam of X-rays relative to the target. For example, the target could have an elliptical, hyperboloid, or other geometry in one or two dimensions.

The X-ray emitter could include collimators, focusing electrodes, or other elements to collimate or otherwise focus electrons emitted from the cathode into a beam of electrodes such that the beam of X-rays emitted from the target when impacted by the beam of electrons is more directional and/or more focused. To facilitate this, the emission of electrons from the cathode could be intrinsically more directional (e.g., compared to thermionic emission from a hot cathode) and/or the energy of the electrons upon emission from the cathode could be reduced. To accomplish these aims, the cathode could be a cold cathode, e.g., a carbon nanotube cold cathode.

Such an intrinsically steerable X-ray emitter could be used as described herein in combination with a robotic wall-climbing backscatter X-ray imaging system. In such examples, the intrinsically steerable X-ray emitter could be configured to control the angle of the beam of X-rays emitted therefrom in only a single direction. Alternatively, such an intrinsically steerable X-ray emitter could be used in other applications. In such applications, the intrinsically steerable X-ray emitter could be configured to control the angle of the beam of X-rays emitted therefrom in two (or more) directions, e.g., by including two (or more) sets of steering electrodes to which voltages (e.g., high voltages) can be applied to control the angle of an electron beam in two (or more) directions, thereby controlling the direction of the beam of X-rays emitted from the target when impacted by the beam of electrons in two (or more) directions.

Another method to improve the image quality of backscatter X-ray system while reducing SWaP for imaging metal or other materials disposed beneath an overlaying layer of insulation or other material is to use collimators or other X-ray-opaque materials to prevent X-rays scattered from the overlayer (e.g., from atoms of an insulation layer that is overlaid on a metal or otherwise-composed wall or other target of interest) from being detected by a detector of the imaging system. This allows the imaging system, for a given SWaP, to have better sensitivity to the geometry, composition, or other properties of the wall by rejecting X-rays scattered from the overlayer, which can be considered ‘noise.’

FIG. 4 depicts, by way of example, one manner in which an X-ray backscatter imaging system 400 can be configured to reject “shallow” scattered X-rays (e.g., X-rays scattered by a superficial layer of insulation or other overlayer material) while detecting “deep” X-rays scattered by a target of interest. An X-ray emitter 410 emits a beam of X-rays (e.g., a beam scanned along one direction, as in the embodiments described elsewhere herein) toward a target 401. Shallow areas of the target 401 (areas above the horizontal dashed line) are not of interest (e.g., correspond to material of an insulator coating or other overlayer) while deeper areas are of more interest (e.g., a metal wall of a pressure vessel to be inspected for corrosion, cracks, or other damage or defects). Atoms of the target 401 absorb or scatter the beam of X-rays, with some of the X-rays being backscattered back toward the imaging system 400 (upward angled arrows). The imaging system 400 includes an X-ray detector 420 and a collimator 430. The collimator 430 is configured to block X-rays scattered from above the dashed line (indicated by dashed-line arrows) from being detected by the detector 420 while allowing X-rays scattered from below the dashed line (indicated by solid-line arrows) to be detected by the detector 420. Note that not all of the X-rays scattered from the shallow region are blocked by the collimator 430; rather, the collimator 430 is positioned to block those X-rays scattered from the shallow region that would likely have been detected by the detector 420 but for the presence of the collimator 430. Similarly, not all of the X-rays scattered from the deep region are detected by the detector 420; some proportion of those scattered X-rays are instead directed in other directions.

The collimator 430 (or other collimators or shields described herein) may include a variety of materials. For example, the collimator 430 may include copper, brass, lead, aluminum, or the like. The collimator 430 and other collimators and/or shields described herein may include a material and thickness suitable to the desired range of energies to be reduced. The collimator 430 could also be configured to substantially block X-rays emitted from the emitter 410 that may propagate to the detector 420 directly and/or as a result of scattering from other elements of the imaging system 400.

The detector (e.g., 420) of a backscatter X-ray imaging system as described herein could be configured in a variety of ways. For example, the detector 420 could be configured as a bar of X-ray sensitive material (e.g., a bar of scintillator material with one or more associated photon detectors, a bar of X-ray-sensitive detector material of a direct detector) arranged along the direction of scanning of the beam of X-rays to facilitate imaging of backscattered X-rays along the entire path of scanning of the beam. In such examples, the collimator 430 could also extend along the length of such a detector. In examples wherein the detector is a multi-pixel detector, information about X-rays detected using multiple pixels could be used to generate image data for each location of a target (e.g., the target 401 wall) that is illuminated by a scanned beam of X-rays.

To facilitate low-SWaP backscatter imaging, the detector of a backscatter imaging system as described herein (e.g., an imaging system of sufficiently low SWaP to be incorporated into a wall climbing robotic inspection system) could be configured to detect information about the wavelength of received X-ray photons or to otherwise detect, in a wavelength-dependent manner, X-ray photons at two or more different wavelengths (e.g., within two or more different bands of wavelengths). Such functionality can facilitate reduced SWaP by allowing the imaging system to select between a number of different detectable wavelengths to select the particular wavelength(s) that will best allow the imaging system to detect the geometry, roughness, or other image information about a target. Additionally or alternative, information about X-rays detected at multiple different wavelengths can be used to improve the determination of the geometry or other image information about a target and/or to identify the material composition of the target (e.g., to identify that oxides or other corrosion-related substances are present at one or more locations of the target).

Detectors of such an imaging system could be configured and/or operated in a variety of ways to facilitate such wavelength-specific detection. For example, such an imaging system could include one or more pulse-photon count detectors operable to detect the energy, and thus to infer the wavelength of, individual incident X-ray photons. Additionally or alternatively, a detector material (e.g., a material of a semiconductor configured to directly detect X-ray photons, a scintillator material configured to transduce X-ray photons into longer-wavelength photons or other energies for detection by indirect detectors) could be selected to be selectively sensitive to certain ranges of X-ray photon wavelengths. For example, a detector may be configured to accept lower energy photons and reject higher energy photons according to a threshold. The threshold may be a point at which the relative acceptance and rejection of the photons at the energy level of the threshold are about equal.

Where X-ray detectors as described herein include scintillators, scintillators may include a variety of materials configured to convert x-ray photons into photons detectable by sensors of another sensor substrate. For example, such scintillators may include cesium iodide (CsI), cadmium tungstate (CdWO₄), polyvinyl toluene (PVT), or the like. Other examples of the scintillator include gadolinium oxysulfide (Gd₂O₂S; GOS; Gadox), gadolinium oxysulfide doped with terbium (Gd₂O₂S:Tb), or the like.

Where X-ray detectors as described herein include direct detectors (e.g., pulse-photon count detectors) the direct conversion sensor substrate may include direct conversion materials including cadmium telluride (CdTe), cadmium zinc telluride (CdZnTe or CZT), selenium, or the like. Such direct conversion detectors create electron-hole pairs. The electron-hole pairs are generated (and may be counted or otherwise measured) by some sensor substrates from the detected photons. The number of electron-hole pairs generated are indicative of the incoming energy of the photons that created them. Accordingly, such direct conversion sensors (e.g., pulse-photon count detectors) and associated electronics can be configured to discriminate based on energy and/or to output the measured energy of detected photons. For example, a direct conversion sensor substrate and associated electronics may be configured to detect and reject signals based on photons having energies above a threshold, such as 600 keV, 1 MeV, or the like, and/or within specified bands of energy (e.g., to facilitate providing multiple wavelength-dependent outputs related to the amount of X-rays detected at respective different wavelengths).

Using information about backscattered X-rays received from a target (e.g., from a particular location of a target) at two or more different wavelengths (e.g., within two or more different ranges of wavelengths) to identify the composition of the target (e.g., to identify the presence of oxides or other corrosion at a particular location of the target) can be accomplished in a variety of ways. For example, a pattern of the intensity or other measurement(s) of the X-rays across the two or more different wavelengths could be compared to a set of known ‘signatures,’ corresponding to respective different material compositions.

The identity of the detected wavelengths (e.g., the extent of different ranges of detected wavelengths) could be selected to enhance the detection or discrimination of different materials. For example, to detect iron, steel, aluminum, or other metals between an insulating overlayer disposed thereon, X-rays at various sets of wavelengths between 20keV and 600 keV could be detected. Nearest neighbors, L2 distance, or other methods could be used to identify, from a set of X-ray measurements at two or more different wavelengths, the composition of a target.

Additionally or alternatively, when the detector of a backscatter X-ray imaging system as described herein is configured to detect backscattered X-rays at two or more different wavelengths, the imaging system could operate to select one of the two or more wavelengths to use to image a target to improve the quality of images generated thereby. This could allow the SWaP of such an imaging system for a given image quality to be reduced by allowing, e.g., the power and such size and weight of the X-ray emitter thereof to be reduced. This is because a particular wavelength to image a given target (or portion of a given target, e.g., portion of a wall of a pressure vessel having a certain curvature) may depend upon the specifics of the target, of any overlaying material (e.g., a layer of insulation), and of the local conditions (e.g., whether the overlayer has absorbed water or other materials, whether the overlayer and/or target metal beneath have exhibited oxidation, corrosion, or other chemical processes). Accordingly, by selecting the particular wavelength on a case-to-case basis, the imaging system need not be configured to ensure satisfactory imaging performance for a pre-specified wavelength across any possible conditions.

Selection of a particular wavelength for imaging a target can include emitting a beam of X-rays toward the target and detection backscattered X-rays at two or more different wavelengths. Based on the detected X-rays, one of the two or more different wavelengths can then be selected and used to perform imaging of the target. Selecting such a wavelength can include, e.g., attempting to generate two or more images of the target (which may be one dimensional images, e.g., surface profiles) based on respective X-rays detected at the two or more different wavelengths and then selecting the one of the two or more wavelengths whose corresponding image of the target is “best” in some respect, e.g., exhibits the least noise.

Although the structures, devices, methods, and systems have been described in accordance with particular embodiments, one of ordinary skill in the art will readily recognize that many variations to the particular embodiments are possible, and any variations should therefore be considered to be within the spirit and scope disclosed herein. Accordingly, many modifications may be made by one of ordinary skill in the art without departing from the spirit and scope of the appended claims.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. These additional embodiments are determined by replacing the dependency of a given dependent claim with the phrase “any of the claims beginning with claim [x] and ending with the claim that immediately precedes this one,” where the bracketed term “[x]” is replaced with the number of the most recently recited independent claim. For example, for the first claim set that begins with independent claim 1, claim 4 can depend from either of claims 1 and 3, with these separate dependencies yielding two distinct embodiments; claim 5 can depend from any one of claims 1, 3, or 4, with these separate dependencies yielding three distinct embodiments; claim 6 can depend from any one of claims 1, 3, 4, or 5, with these separate dependencies yielding four distinct embodiments; and so on.

Recitation in the claims of the term “first” with respect to a feature or element does not necessarily imply the existence of a second or additional such feature or element.

1. A system comprising:
a wall-climbing robot, wherein the wall-climbing robot is configured to selectively attach to a wall while moving along the wall in a first direction relative to a body of the wall-climbing robot;
an X-ray emitter, wherein the X-ray emitter is operable to generate a beam of X-rays and the scan the beam of X-rays in a second direction that is substantially perpendicular to the first direction; and
an X-ray detector, wherein the X-ray detector is operable to detect X-rays emitted from the X-ray emitter and scattered back toward the X-ray detector from the wall.

2. The system of claim 1, wherein a direction of the beam of X-rays in the second direction is controllable by controlling a direction of a beam of electrons emitted from a cathode of the X-ray emitter toward a target of the X-ray emitter.

3. The system of claim 2, wherein the cathode of the X-ray emitter is a carbon nanotube cold cathode.

4. The system of claim 1, further comprising:
a controller comprising one or more processors and configured to perform controller operations including:
operating the X-ray emitter to emit the beam of X-rays and to scan the beam of X-rays along the second direction, thereby illuminating a plurality of locations of the wall;
operating the X-ray detector to detect X-rays emitted from the X-ray emitter and scattered back toward the X-ray detector from the plurality of locations of the wall; and
based on the detected X-rays, determining at least one of a geometry of the wall along the plurality of locations or a presence of an oxide at at least one of the plurality of locations.

5. The system of claim 4, wherein the beam of X-rays emitted from the X-ray emitter is polychromatic and wherein the X-ray detector is operable to detect X-rays at at least two wavelengths of the polychromatic beam of X-rays.

6. The system of claim 5, wherein the X-ray detector comprises a pulse-photon count detector.

7. The system of claim 5, further comprising:
a controller comprising one or more processors and configured to perform controller operations including:
during a first period of time, operating the X-ray emitter to emit the beam of X-rays to illuminate the wall;
during the first period of time, operating the X-ray detector to detect X-rays emitted from the X-ray emitter and scattered back toward the X-ray detector from the wall at the at least two wavelengths;
based on the detected X-rays, selecting at least one of the at least two wavelengths;
during a second period of time, operating the X-ray emitter to emit the beam of X-rays and to scan the beam of X-rays along the second direction, thereby illuminating a plurality of locations of the wall;
during the second period of time, operating the X-ray detector to detect X-rays emitted from the X-ray emitter and scattered back toward the X-ray detector from the plurality of locations of the wall at the selected at least one of the at least two wavelengths; and
based on X-rays detected during the second period of time, determining at least one of a geometry of the wall along the plurality of locations or a presence of an oxide at at least one of the plurality of locations.

8. The system of claim 5, further comprising:
a controller comprising one or more processors and configured to perform controller operations including:
operating the X-ray emitter to emit the beam of X-rays to illuminate the wall;
operating the X-ray detector to detect X-rays emitted from the X-ray emitter and scattered back toward the X-ray detector from the wall at the at least two wavelengths; and
based on the detected X-rays at the at least two different wavelengths, identifying a composition of a material that scattered the detected X-rays at the at least two different wavelengths.

9. The system of claim 1, further comprising a collimator configured to prevent the X-ray detector form detecting X-rays emitted from the X-ray emitter that are scattered by material of the wall that is less than a threshold distance from the X-ray emitter.

10. The system of claim 1, wherein the wall-climbing robot comprises a vacuum source that is operable to selectively apply a vacuum to the wall, thereby allowing the wall-climbing robot to selectively attach to the wall.

11. The system of claim 1, wherein the X-ray detector comprises a pulse-photon count detector.

12. A system comprising:
an X-ray emitter, wherein the X-ray emitter is operable to generate a beam of X-rays that comprises X-rays at a plurality of different wavelengths and to scan the beam of X-rays in at least one direction;
an X-ray detector, wherein the X-ray detector is operable to detect the wavelength of X-rays received by the X-ray detector; and
a controller comprising one or more processors and configured to perform controller operations including:
operating the X-ray emitter to emit a beam of X-rays toward a first location of a target; and
operating the X-ray detector to detect X-rays at at least two different wavelengths that are emitted from the X-ray emitter and scattered from the first location of the target.

13. The system of claim 12, wherein the X-ray detector comprises a pulse-photon count detector

14. The system of claim 12,further comprising a collimator configured to prevent the X-ray detector form detecting X-rays emitted from the X-ray emitter that are scattered by material that is less than a threshold distance from the X-ray emitter.

15. The system of claim 12, wherein the controller operations further comprise:
based on the detected X-rays at the at least two different wavelengths, identifying a composition of a material that scattered the detected X-rays at the at least two different wavelengths.

16. The system of claim 12, wherein the controller operations further comprise:
based on the detected X-rays, selecting at least one of the at least two wavelengths;
during an additional period of time, operating the X-ray emitter to emit the beam of X-rays and to scan the beam of X-rays along the at least one direction, thereby illuminating a plurality of locations of the target;
during the additional period of time, operating the X-ray detector to detect X-rays emitted from the X-ray emitter and scattered back toward the X-ray detector from the plurality of locations of the target at the selected at least one of the at least two wavelengths; and
based on X-rays detected during the additional period of time, determining at least one of a geometry of the target along the plurality of locations or a presence of an oxide at at least one of the plurality of locations.

17. The system of claim 12, wherein the X-ray emitter is operable to scan the beam of X-rays in two substantially perpendicular directions, and wherein the controller operations further comprise:
operating the X-ray emitter to emit the beam of X-rays toward a plurality of locations of the target that vary with respect to both of the two substantially perpendicular directions;
operating the X-ray detector to detect X-rays at the at least two different wavelengths that are emitted from the X-ray emitter and scattered back toward the X-ray detector from the plurality of locations of the target; and
based on the detected X-rays, determining a two-dimensional image of a geometry of the target.

18. The system of claim 12, wherein a direction of the beam of X-rays is controllable by controlling a direction of a beam of electrons emitted from a cathode of the X-ray emitter toward a target of the X-ray emitter.

19. The system of claim 18, wherein the cathode of the X-ray emitter is a carbon nanotube cold cathode.

20. The system of claim 18, wherein the X-ray detector comprises a pulse-photon count detector.
